(19) United States
(12) Patent Application Publication
(10) Pub. No.: US 2014/0279701 A1
(43) Pub. Date: Sep. 18, 2014

(54) ASSET ALLOCATION BASED SYSTEM FOR INDIVIDUAL INVESTOR PORTFOLIO SELECTION

(71) Applicant: Adviceware, Rocky River, OH (US)

(72) Inventor: Darrin B. Farrow, Westlake, OH (US)

(73) Assignee: Adviceware, Rocky River, OH (US)

(21) Appl. No.: 14/215,735

(22) Filed: Mar. 17, 2014

Related U.S. Application Data
(60) Provisional application No. 61/789,991, filed on Mar. 15, 2013.

(51) Int. Cl. G06Q 40/06

(52) U.S. Cl. CPC G06Q 40/06
USPC 705/36 R

(57) ABSTRACT

A system for implementing an investment methodology that uses expertly managed funds to automatically manage the investments in a retirement account to take into account various investor information, including the investor age, beneficiary status information, projected retirement plans, among others. The methodology allows use of target-date age-based funds, fixed risk/return funds, or both in a manner that can accommodate not only the investor's retirement plans and status, but also the status of the investor's beneficiaries. Also, the system can automatically implement dollar cost averaging for moving or otherwise purchasing investments in funds.

### CROSS-REFERENCES TO RELATED APPLICATIONS

This application claims the benefit of U.S. Provisional Application, Ser. No. 61/789,991 filed on Mar. 15, 2013, and incorporated herein by reference.

### BACKGROUND

Modern portfolio theory studies have shown that most investor investment performance is due to asset allocation. For individual investors who attempt to follow this principle, the task of allocating investment or retirement dollars among the thousands of marketed securities is formidable, and to be done successfully requires extensive knowledge of securities markets and investing experience. For these reasons, investing in securities was, in the past, done almost exclusively by trained professionals (i.e., experts with the appropriate expertise) experienced in the markets and securities selection. The advent of discount brokerage services and the Internet have provided easy access to the purchase and sale of securities to virtually everyone. Although Internet based on-line trading systems have made the process of buying and selling securities very simple and economical, such systems have, unfortunately, proven to actually increase the probability for most investors of losing money, particularly those investors who have little or no experience in long term investing.

The assets of pensions and profit sharing plans of corporations and other types of entities have also traditionally been managed by professional investors. The creation of 401(k) type self-directed retirement accounts compelled employees to make their own investment decisions, albeit typically from a relatively small set of plan choices. The investment allocation of retirement funds is usually done by providing employees with a small, limited list of investment funds from which to choose, and requiring the employee to designate an allocation percentage of their contribution dollars to one or more of the available funds. Some basic information about the funds, such as investment objective and performance history, is also provided. With only this skeletal information, plan participants are expected to correctly allocate their retirement funds for optimal return, a daunting task. Furthermore, there are often restrictions on the frequency with which any reallocation of funds can be made. Hence, such accounts also show a tendency to have non-optimal returns.

One approach that has proven less than satisfactory in practice is providing the investor with an option to invest in a target date fund, also referred to as life style, life cycle, and target risk funds (for simplicity, the phrase “target date” will be used to correspond to any portfolio for which the portfolio itself is adjusted for risk to become more conservative over time). Such funds us age-based asset allocations that are formulated according to specific age ranges, or projected retirement dates, of the individual investor (or the funds may be based on life expectancies or some other criteria). Current implementations of target date strategies are typically managed in a manner that transitions the asset allocation of a given investor's plan over time. Such funds mover, over time, from a higher risk, higher return model (e.g., with a heavier preponderance of stocks) when the investor is younger with many more work years until retirement, to a more conservative, lower return, lower risk asset allocation within the same model (e.g., fewer stocks and more bonds and money markets) as the investor ages. However, such target date funds actually often underperform risk based funds and other investments and/or the market. This can possibly be due to money managers basing their asset allocation on Monte Carlo Simulations, which utilize historical data to predict future outcomes in the market. It may also, or alternatively, be because the expertise required to manage the fund over time changes as the asset classes change (whereas the experts managing the fund tend to be static or not change sufficiently in expertise as the fund matures), thereby making it difficult to ensure that the plans are optimally managed according to its changes in investments. Furthermore, such target date funds do not typically take into account the age of the investor's spouse or other beneficiaries of the retirement account, potentially leading to sub-optimum investment strategies for particular investors, such as when an investor has an unusually young spouse or unusually young children, for example.

In an attempt to provide assistance to this task, retirement planning guides have proliferated, many providing supposedly more practical approaches which focus on participants' projected financial needs, rather than trying to teach investment strategies. Because money management and investing has significant behavioral and emotional components, many planners make an assessment of how the participant handles or responds to these aspects of investing. This information or assessment is then used to recommend certain investments, typically mutual funds and/or ETFs, to the participant. The participant is, however, again typically left to make the final investment decisions on their own. So even though the individuals have been provided with some additional assistance in the process, this methodology of retirement planning does not remove the participant—who is most likely a novice at investing—from making the most critical and important decisions which will directly impact their total return.

Furthermore, such retirement accounts, among others, fail to take advantage of an investment strategy that helps to mitigate the risks of price changes in securities. Dollar Cost Averaging (DCA) is often used by investors to purchase a security or other investment using a fixed dollar amount regularly over time. Such an approach helps to smooth out variations in the costs of the investment, because, when the price of a security drops, more “shares” are purchased, but when the price rises, fewer “shares” are purchased. Such an approach has proven to reduce the risk of an individual investor being adversely impacted by swings in the prices of the investment. But DCA approaches have not been provided in retirement plans such as 401(k)s, and other participant directed plans, likely due to complexity of implementation, hence depriving investors of the benefits of such an approach.

Many different computer software-based approaches have been utilized for investment and retirement account management, many of which tend to focus on data acquisition and information processing of investor profiles, which are then matched to an appropriate portfolio by a professional investment manager. Financial planning software, whether creating an investor profile including time periods of contributions and withdrawals and risk tolerance, or selecting investments which match a developed profile, all lead to the point at which specific investment decisions must be made on an individual basis for each plan participant, hence having many or all of the shortcomings identified above.

U.S. Pat. No. 8,442,889 filed on Jul. 12, 2004 and incorporated herein by reference, discloses a means of providing managed investment in securities by allocation of assets among a group of asset classes in an investment portfolio according to an investor's responses to a questionnaire for obtaining information about the investor and the investor's financial situation, plans, and desires. The system ascertains the investor's tolerance for fluctuation in the value of the portfolio, generating a plurality of model portfolios with each model portfolio having different allocations of assets among a group of asset classes. These model portfolios are represented by asset class allocation percentages, and determine a correlation between an investor's collective responses to the questionnaire and the model portfolios from which a model portfolio is selected. The system then recommends to the investor a specific model portfolio based upon the investor's responses to the questionnaire, although the investor is permitted to choose another one of the model portfolios, if desired.

However, the prior art fails to address the situation where an investor refuses or is otherwise unable to complete the survey, or where the investor refuses to or otherwise cannot select any of the proposed model portfolios. The prior art also fails to adequately address situations where the ages of the spouse, or other intended beneficiaries, are substantially different from the investor's age. Finally, as discussed above, the prior art fails to provide the ability of using dollar cost averaging approaches to retirement accounts. A means of providing satisfactory investment approaches for such investors is hence desirable.

### SUMMARY

Disclosed are example embodiments of a system and methodology for selection of a predetermined investment portfolio which are properly allocated in accordance with applicable time periods, investor age, potential retirement dates, and risk tolerance of individual investors in situations where the investor may not want to actively participate in the selection process. The investor is not required, and typically is not enabled by the system to pick specific funds or securities in order to achieve an appropriate allocation, and the investor may avoid completing detailed surveys that otherwise might be useful in determining the investor's risk tolerance and investment goals. The system provides a plurality of model portfolios with differing allocations including, but not limited to stocks, bonds, money market, cash or cash equivalent. In certain circumstances for certain investors, the system automatically selects one of the model portfolios based on the investor's age and/or retirement schedule and the designated age bands determined for the portfolio. Triggering events in sequence, referred to as age band jumping, can be controlled by portfolio manager, and/or fiduciary/responsible party having decision making authority. Then, over time, the system will age band jump or transition the investor to another one of the model portfolios better matched to the investor's current age, retirement schedule, current beneficiaries, life expectancy, or some combination of these. Each of the model portfolios, however, can be managed by experts with substantial expertise in managing that type of portfolio, and each one of the model portfolios can be managed based on consistent goals and objectives that may or may not change over time. For at least some embodiments, the individual investor or plan participant is never required to pick specific investment vehicles.

Also disclosed are one or more example embodiments that can apply the feature of dollar cost averaging to such retirement investment accounts.

Further provided are a plurality of example embodiments, including, but not limited to, a method of automatically assigning an investor in a retirement plan to a model portfolio, and a system including at least one computer executing software for implementing the method, said method comprising the steps of:
providing a plurality of model portfolios, wherein each one of said model portfolios is managed according to different stable risk/return requirements or wherein the risk/return of each portfolio changes over time;
assigning each one of said model portfolios to a different investment category;
receiving information regarding the age and/or retirement goals of the investor;
determining a current investor investment category for the investor based on the age and/or retirement goals of the investor;
selecting a first one of said model portfolios based on the current investment category of the investor matching the investment category of the selected one of the model portfolios, wherein
a portion of the assets of the retirement account of the investor are invested in the first one of the model portfolios;
periodically determining an updated investor investment category for the investor based on updates to the age and/or retirement goals of the investor, wherein
If the updated investor investment category has changed from said current investor investment category, selecting a second one of said model portfolios different than the first one of the model portfolios based on the updated investment category of the investor matching the investment category of the second one of the model portfolios, and wherein
at least a portion of the assets of the retirement account of the investor are moved from the first one of the model portfolios to the second one of the model portfolios.

Also provided is the system and/or method above further comprising the step of receiving information regarding the age and/or retirement goals of a beneficiary of the investor, wherein said step of determining a current investor investment category for the investor is also based on the age and/or retirement goals of the beneficiary of the investor.

Further provided is the system and/or method above, wherein said step of periodically determining an updated investor investment category for the investor is also based on updates to the age and/or retirement goals of the beneficiary of the investor.

Still further provided is a method of automatically incrementally investing in a model portfolio to implement dollar cost averaging in a retirement account, and a system including at least one computer executing software for implementing the method, said method comprising the steps of:
receiving information about a desired incremental investment in the model portfolio;
automatically determining a purchase schedule for investing in the model portfolio in an incremental fashion;
automatically investing in said model portfolio in the incremental fashion according to the determined purchase schedule such that said automatically investing includes a plurality of purchases occurring at different times.

Also provided is a method of automatically investing or divesting in a model portfolio in a retirement account based on market conditions, and a system including at least one computer executing software for implementing the method, said method comprising the steps of:
receiving information about desired investment or divestment in the model portfolio and the selected market conditions for triggering said investment or divestment;
monitoring the actual market conditions;
when the actual market conditions match the selected market conditions, automatically implementing the desired investment or divestment of the model portfolio.

Further provided is a method of performing automated investing in a retirement account using a computer system comprising at least one computer and at least one database, said method comprising the steps of:
providing a plurality of model investment portfolios each directed toward different investment criteria;
collecting investor information about a particular investor using said computer system, wherein said information is stored in at least one of said at least one database;
accepting information into said computer system indicating a retirement investment amount of the particular investor;
determining, using said computer system, particular life-circumstances for a particular investor utilizing the investor information;
automatically choosing, using said computer system, a plurality of chosen model investment portfolios chosen from the plurality of model investment portfolios, wherein said choosing is at least partly based on the particular life-circumstances of the particular investor; and
automatically determining, using said computer system, a different calculated portion of the retirement investment amount of the particular investor to be allocated to each one of the plurality of chosen model investment portfolios, wherein said determining is at least partly based on the particular life-circumstances of the particular investor;
investing, using the computer system, at least a portion of the retirement investment amount of the particular investor into the chosen model investment portfolios according to the respective calculated portions;
detecting, using the computer system, a threshold change in the life circumstances of the particular investor; and
in response to detecting the threshold change, adjusting the portions invested in the chosen model investment portfolios.

Also provided is a method of performing automated investing in a retirement account using a computer system comprising at least one computer and at least one database, said method comprising the steps of:
providing a plurality of model investment portfolios each directed toward different investment criteria;
collecting investor information about a particular investor using a communication device connected to said computer system via a communication network, wherein said information is stored in at least one of said at least one database;
accepting information into said computer system indicating a retirement investment amount of the particular investor from another communication device connected to said computer system;
determining, using said computer system, particular life circumstances for a particular investor utilizing the investor information, wherein said particular life circumstances include a status of the investor, a status of a spouse of the investor and a status of each of any children of the investor;
automatically choosing, using said computer system, at least one chosen model investment portfolio chosen from the plurality of model investment portfolios, wherein said choosing is dependent on all of the status of the investor, the status of the spouse of the investor, and the status of any children of the investor;
automatically determining, using said computer system, a calculated respective portion of the retirement investment amount of the particular investor to be allocated to each one of the at least one chosen model investment portfolio, wherein said determining is at least partly based on all of the status of the investor, the status of the spouse of the investor, and the status of any children of the investor; and
investing, using the computer system, the retirement investment amount of the particular investor into the at least one chosen model investment portfolio according to the respective calculated portion(s).

Further provided is a method of performing automated investing in a retirement account using a computer system comprising at least one computer and at least one database, said method comprising the steps of:
providing a plurality of model investment portfolios each expertly managed to provide a different level of risk and return;
collecting investor information about a particular investor using a communication device connected to said computer system via a communication network, wherein said information is stored in at least one of said at least one database;
accepting information into said computer system indicating a retirement investment amount of the particular investor;
determining, using said computer system, particular life-circumstances for a particular investor utilizing the investor information, wherein said particular life circumstances include a status of the investor;
automatically choosing, using said computer system, a plurality of chosen model investment portfolios chosen from the plurality of model investment portfolios, wherein said choosing is at least partly based on at least the status of the particular investor;
automatically determining, using said computer system, a different calculated portion of the retirement investment amount of the particular investor to be allocated to each one of the plurality of chosen model investment portfolios, wherein said determining is based at least on the status of the particular investor;
investing, using the computer system, the retirement investment amount of the particular investor into the chosen model investment portfolios according to the respective calculated portions;
detecting, using the computer system, a threshold change in the status of the investor;
in response to detecting the threshold change in the status of the investor, automatically re-choosing, using said computer system, a updated plurality of chosen model investment portfolios chosen from the plurality of model investment portfolios, wherein said re-choosing is at least partly based on the change in the status of the investor;
also in response to detecting the threshold change in the status of the investor, automatically determining, using said computer system, a different calculated portion of the retirement investment amount of the particular investor to be allocated to each one of the plurality of further chosen model investment portfolios, wherein said determining is based at least on the change in the status of the particular investor; and
in response to determining the different calculated portion, re-investing, using the computer system, an updated retirement investment amount of the particular investor into the updated chosen model investment portfolios according to the respective different calculated portions, wherein said re-investing includes selling at least a part of the current investment in one or more of the chosen model investment portfolios.

Also provided are any of the above methods, further comprising the steps of:
detecting, using the computer system, a threshold change in the status of the investor;
in response to detecting the threshold change in the status of the investor, automatically re-choosing, using said computer system, an updated chosen at least one of the plurality of model investment portfolios, wherein said re-choosing is at least partly based on the change in the status of the investor; and
in response re-choosing, re-investing, using the computer system, at least a portion of a current retirement investment amount of the particular investor into the updated chosen at least one of the model investment portfolios.

Further provided are any of the above methods wherein the change in status of the investor is based on a change in the age of the investor, a change in a beneficiary of the investor, or both.

Also provided are additional example embodiments, some, but not all of which, are described herein below in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a block diagram showing an example high-level hardware design of the example system;

FIG. 1A is a block diagram showing example functional relationships between example elements of the example system;

FIG. 2 shows a plurality of example model portfolios that can be used by the example system;

FIG. 3 is a flow chart showing an example process of allocating a model portfolio to an investor;

FIG. 3A is a flow chart showing another example process of allocating a model portfolio to an investor.

FIG. 4 is a flow chart showing an example process for implementing an example Auto Pilot Dollar Cost Averaging (APDCA) function;

FIG. 5 is an example screen shot providing an input screen for an investor implementing an example APDCA function; and

FIG. 6 is an example screen shot providing an input screen for investors setting an example APDCA process made dependent upon various market conditions or changes.

### DETAILED DESCRIPTION OF THE EXAMPLE EMBODIMENTS

As will be appreciated by one of skill in the art, examples of the disclosed innovations may be embodied as a method, a system, an application, a computer program product, software executing on a processor/computer or a plurality thereof, or a combination of the foregoing. The example embodiments may take the form of an entirely hardware reliant implementation, or, more likely, an implementation that combines software (including one or more of firmware, resident software, microcode, scripts, etc.) and hardware components for executing the software. The software may be stored on any appropriate computer usable storage medium by having computer-usable program code embodied in the medium, which may be packaged as a computer program product, for example. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CDROM), or other tangible optical or magnetic storage device; or transmission media such as those supporting the Internet or an intranet. Note that the computer usable or computer readable medium could even include another medium from which the program can be electronically captured, via, for instance, optical or magnetic scanning for example, then compiled, interpreted, or otherwise processed in a suitable manner, if necessary, and then stored in a computer memory of any acceptable type.

The computer program instructions for implementing any of the example embodiments may be stored or otherwise loaded in a computer-readable memory that can direct a computing device or system, or other programmable data processing apparatus such as described above, to function in a particular manner, such that the instructions stored in the computer readable memory produce an article of manufacture including instruction means which implement the function/act specified in the flowchart and/or block diagram block or blocks.

The software comprises computer program instructions that are executed by being provided to an executing device or component, which will typically include a processor of a general purpose computer, a special purpose computer or controller, or other programmable data executing apparatus or component, such that the instructions of the computer program, when executed by the respective hardware, create means for implementing the functions/acts specified in the software, as may be represented in the flowchart and/or block diagram block or blocks of the figures. Hence, the computer program instructions are used to cause a series of operations to be performed on the executing device or component, or other programmable apparatus to produce a computer implemented process such that the instructions which execute, on the computer or other programmable apparatus, the steps for implementing the functions/acts specified in this disclosure. These steps or acts may be combined with operator or human implemented steps or acts and steps or acts provided by other components or apparatuses in order to carry out any number of example embodiments.

Specifically disclosed are example embodiments of systems and methodologies for selection of predetermined investment portfolios which are properly allocated in accordance with applicable time periods, investor age, potential retirement dates, and the determined risk tolerance of individual investors in situations where the investor may not want to actively participate in the asset selection process. For example, the system disclosed in previously cited U.S. Pat. No. 8,442,889, filed on Jul. 12, 2004 and incorporated herein by reference (hereinafter the '889 patent), requires the investor to complete a questionnaire providing a series of questions concerning time frames, risk tolerance, appreciation targets, and percentage of total assets to be invested, for example, which is then used by the disclosed system to automatically select an asset allocation model based upon the investor's responses to the questions. However, in some cases, the investor may refuse to complete such a questionnaire, may neglect to do so within a reasonable time, or the investor may be unable to complete the questionnaire for some reason (e.g., a medical or mental disability). For at least some embodiments of the system disclosed herein, the individual investor is never required to pick specific investment vehicles. In other embodiments, a questionnaire as disclosed in the '889 patent can be used to obtain information used to select a proper target date fund for a given investor. Such processes provided by the system may be used in replacement or selection of target date funds for automatic enrollment e.g., QDIA or re-QDIA commonly referred to as qualified default investment account.

The answers of the questionnaire can be used to gather investor information to determine certain investor life circumstances that can be used by the system to automatically optimize the selection of appropriate investments of the investor for investing a desired investment amount (which may be the entire balance of an IRA or 401(k) or other retirement account, or only a portion thereof). Such life circumstances can include the investors age, desired or projected retirement dates, number of children and their ages and educational status, whether the investor has a spouse and the age and retirement information of that spouse, among others.

For example, the questionnaire might inquire as to the investor's age, marital status, number and ages of children, level of education of the investor and any spouse and children, career choice, retirement plans, etc. This information could then be used to determine expected retirement dates of the investor and the investor's spouse, expected education expenses of the investor's children, etc. For example, an investor who has a professional degree with a spouse having a professional degree would be expected to retire at an age consistent with that profession, and such an investor would also be expected to send the children to a professional school or college.

For the improved system disclosed herein, the system can execute a method to provide for an investor who avoids completing a survey, as described above, while still providing some accommodation for determining the investor's risk tolerance and investment goals. This system provides a plurality of model portfolios with differing allocations among stocks, bonds, money market, cash, or cash equivalent, which may be as provided as disclosed in the '889 patent, for example, or by some other method. When the individual investor refuses or otherwise fails to participate in the determination of a proper investment, such as by not completing the questionnaire which may be provided by the system, or by indicating that he or she will not fill out such a questionnaire, the system may automatically determine certain investor life circumstances from whatever personal information about the investor that the system has access to.

The system then selects one of the model portfolios based on an assessment of which portfolio provides the best balance of return and risk for the particular investor's life circumstances (such as age and/or retirement schedule and/or life expectancy and/or selected beneficiaries, and/or some combination of these criteria.

For example, for an investor who is young, and likely has many years left until retirement (e.g., may be between 20 and 30 years old in 2013 and thus may be intending to retire in the decade of 2050), the system can choose a model portfolio that is intended to initially generate higher returns, but that entails a higher risk as well, such as a portfolio that is invested heavily or completely in stocks. In contrast, an investor who is closer to half-way through his or her expected work years (e.g., may be between 30 and 40 years old and/or intending to retire in the 2040's), the system can choose a model portfolio that initially tends to be less risky, but that also will likely generate lower returns, such as a portfolio that is more evenly balanced in stocks and bonds, for example. But an investor who is near retirement (e.g., may be over 60 years old and/or retiring in the current decade), in contrast, would be put into an initially lower risk model portfolio more directed at preserving equity and generating income, such as a fund that invests primarily in bonds and money markets, for example.

Alternatively, the system could use traditional age-based target date model portfolios where the asset allocation of the portfolio itself changes over time to adjust risk and return.

For the risk-based model portfolio approach, once the appropriate model portfolio is chosen based on the investor's age and/or retirement schedule and/or life expectancy, the system will then move the investor to a different model portfolio at some point in the future as the investor ages or otherwise gets closer to the determined (or desired) retirement age (and thus closer to the investor's expected end of life). Note that the securities or other investments of the chosen risk-based model portfolios themselves are not changed based on this transition of the investor; instead, at least part of the investor's assets are moved to another one of the model portfolios based on the investor's changing circumstances of falling into a new age category, or by becoming a certain smaller distance from his or her projected retirement age (or expected end of life).

Such an approach is very different than investing in age-based target date funds, as the investment assets of the target date funds are themselves changed based on the passage of time (i.e., the investor aging), whereas for the risk-based model portfolios used for this example, the investments of each model portfolio remain based upon the original objectives of the given portfolio, which are independent of the investor's age or distance from retirement (or end of life), but that are instead based solely or primarily on the prescribed investment criteria for that model portfolio (e.g., risk/benefit), which does not typically change over time, or only rarely changes for some reason other than the aging of the investors currently invested in them. This allows each of the model portfolios to be managed by a specialist for that particular investment style, and instead investor assets are moved between different model portfolios as the investor's life situation changes.

Note that different example systems may utilize age-based target date model portfolios, risk-based model portfolios, or a combination of these portfolios for retirement investing, as described in more detail below.

Furthermore, a more advanced system can also be adapted to take into account the age, education level, employment status, and other circumstances of the investor's spouse or designated significant other, and it could also be adapted to take into account the circumstances of the other intended beneficiaries of the investor, such as children or other designated beneficiaries. This feature could be implemented by considering not only the investor's age and/or retirement plans and/or life expectancy, but also these parameters for the investor's spouse/significant other, and/or other beneficiaries (e.g., children). Hence, the choosing of an appropriate model portfolio can be influenced by any or all of these factors.

The system that considers both the investor's age and retirement plans, and his or her beneficiaries, could utilize risk-based model portfolios in a manner described in this specification, such that assets are moved from riskier, higher return model portfolios to less risky, lower return portfolios (with the individual portfolios themselves not changing their risk/return criteria) as the investor and the beneficiaries aged, utilizing a formula that takes the circumstances of all of them into account.

Alternatively, the system could utilize age-based portfolios (e.g., using target date funds) of the type that currently exist in some retirement accounts (where the assets are changed in the portfolio itself to reduce risk and decrease returns over time). In this case, the investors' funds can be allocated to different age-based portfolios to account for the life circumstances of both the investor and the beneficiaries. Thus, for example, portions of the desired investment amount might go to age-based funds appropriate for each of the children (tending to be higher risk and having a longer time horizon), a portion may be invested according to the expected retirement age of the spouse, and the rest may be invested based on the expected retirement age of the investor.

The portions of the desired investment amount that are allocated based on the children, spouse, and investor can vary based on results of the investor questionnaire, the employment circumstances of the spouse and children, the age differences, etc., and hence these portions can be determined as part of the investment formula. In cases where a spouse does not work, a larger portion of the investment may be directed at the spouse's circumstances, than in cases where the spouse works and has a separate retirement plan. Once the investment is made, unlike for the risk-based portfolio approach, there may be no need to move the investment from one fund to another, absent a major life change (such as the birth of another child, for example).

As an example, if the spouse of the investor is much younger than the investor, in a risk-based portfolio system, the transition from high gain, high risk model portfolios to a lower gain, lower risk model portfolio may be delayed compared to the alternative where only the investor's individual information is taken into account. Furthermore, where the investor desires to support minor beneficiaries even after his or her death, such transition delays might also be appropriate, and thereby implemented by the system. In this manner, the expanded system can take into account not just the investor's financial needs, but also the needs of his or her beneficiaries.

In contrast, for the above example using an age-based portfolio system, a formula can be used to determine the initial investments into appropriate age-based funds based on the ages of the investor, the spouse, and any other beneficiaries, and such investment may be maintained indefinitely in those same funds, as it is the funds themselves that change over time in an age-based system.

As another example, in a situation where the investor's spouse is much younger than the investor, and/or where the children are unusually young, the acceptable risk and needed return of an investment to meet the goals of providing for such beneficiaries may require more aggressive investing than would otherwise occur based solely on the investor's personal information.

Accordingly, in a risk-based system, after a certain time period (e.g., when the investor falls into another age band or falls within a certain time from retirement or expected end of life), or after a change in life circumstances (e.g., the birth of a child, or a new marriage, or the transition of a substantial amount of time, such as a number of years or decades), the system can transition the investor to another one of the risk-based model portfolios better matched to the investor's changed age and/or life circumstances.

Each one of the risk-based model portfolios, however, will remain managed by experts with substantial expertise in managing the type of investments ideal for a given model portfolio, and thus each one of the model portfolios can be managed based on persistent goals and objectives that do not change over time (or only rarely change) so that the risk/return profile of the portfolios remain stable and consistent over time. This allows the risk-based model portfolios to remain managed by experts with the proper focused expertise for the given model portfolio's objectives, but also provides for an automatic transition of an individual investor from one model portfolio (at one risk/return level) to another model portfolio (at another risk/return level) over time, meeting that individual investor's investment needs without requiring any changes in the investments of the risk-based model portfolios to do so.

In contrast, in an age-based, target date system, the above example will allocate the investment funds across the age-based funds in a manner determined to likely meet the needs of the various beneficiaries, but those initial investments may be maintained indefinitely unless there is a major life change.

Generally, the system, regardless of the types of funds being used, will not change the investments continuously, but will wait for certain thresholds in investor status to occur before updating the investments. For example, the system may update the investments every 2, 5, or 10 years, for example, or when the investor changes jobs, or changes the desired retirement date, or hits certain age milestones, or retires, or changes a beneficiary (such as by getting married, divorcing a current spouse, adding one or more children, one or more children graduating or decided to go to, or forgo, college, etc.).

FIG. 1 provides a block diagram showing an example hardware implementation of an example embodiment of the system. The example system will include a computer system that typically comprises at least one server 10 connected to at least one database 11. The server 10 is connected to external computers by a public communication network 15, such as the Internet or another communication network, which may be public or private, for example. External computers can include investor computers 12 for use by investors accessing the system, expert computers 14 for use by experts (such as financial planners, for example) accessing the system, and plan sponsor computers 16 for the sponsors of the retirement plan (such as plan managers and fiduciaries, for example) accessing the system, among others. System administrator computers 17 may be connected to the servers 10 by an internal network (e.g., Ethernet), or through the public communication network 15, for example, for system administrators accessing the system. Each of these access points may have different levels of system access so that each user can interact only with portions of the system appropriate for that user.

The example system will be implemented using software that is executed on the computer system, such as on the server 10, for example, and some software may be distributed to the various external computers or other internal computers, such as through the use of scripts or other code, for example. The system could be implemented in a cloud-based arrangement, where the server 10 and database 11 are provided by a service provider, for example. Generally, the example system can be implemented by executing software using the computer system.

Any suitable computerized device comprising a processing component (e.g., a processor) and a computer readable medium may be utilized for providing computers and/or servers of the example embodiments. Generally, a computer usable or computer readable medium that may be any medium that can contain, store, communicate, propagate, or transport the program for use by or in connection with the instruction execution system, platform, apparatus, or device is also included in the computer system. The computer usable medium may include a propagated data signal with the computer-usable program code embodied therewith, either in baseband or as part of a carrier wave. The computer usable program code may be transmitted using any appropriate medium, including but not be limited to the Internet, wireline, optical fiber cable, radio frequency (RF) or other means.

The computer readable medium may comprise, for example but not limited to, an electronic, magnetic, optical, electromagnetic, infrared, or semiconductor system, apparatus, device, database, or propagation medium. More specific examples of the computer readable medium would include, but are not limited to, a computer diskette, a hard disk, a random access memory (RAM), a read-only memory (ROM), an erasable programmable read-only memory (EPROM or Flash memory) which may be internal or external, permanent or removeable, a compact disc read-only memory (CDROM) or random access memory (CDRAM), or any other tangible optical, electrical, magnetic, or other storage device; or storage found on transmission media such as those supporting the Internet or an intranet, including temporary cache memory.

Computer program code for carrying out operations of the example embodiments may be written by conventional means using any computer language, including but not limited to, an interpreted or event driven language such as BASIC, Lisp, VBA, or VBScript, or a GUI embodiment such as visual basic, a compiled programming language such as FORTRAN, COBOL, or Pascal, an object oriented, scripted or unscripted programming language such as ASP Java, JavaScript, Perl, Smalltalk, C++, Object Pascal, or the like, artificial intelligence languages such as Prolog, a real-time embedded language such as Ada, or even more direct or simplified programming using ladder logic, an Assembler language, or directly programming using an appropriate machine language.

The software used for implementing the methodology on the computer system comprises computer program instructions that are executed by being provided to an executing device or component (e.g., the server 10), which can include a processor of a general purpose computer, a special purpose computer or controller, or other programmable data processing apparatus or component, such that the instructions of the computer program, when executed, create means for implementing the functions/acts specified in the flowchart and/or block diagram block or blocks. Hence, the computer program instructions are used to cause a series of operations to be performed on the executing device or component, or other programmable apparatus to produce a computer implemented process such that the instructions will execute on the computer or other programmable apparatus.

The steps for implementing the functions/acts are specified in this disclosure. These steps or acts may be combined with operator or human implemented steps or acts and steps or acts provided by other components or apparatuses in order to carry out any number of example embodiments.

The flowcharts and/or block diagrams in the drawings illustrate example architecture, functionality, and operation of possible implementations of systems, methods and computer program products according to various example embodiments of the system. In this regard, each block in the flowchart or block diagrams may represent a module, segment, or portion of code that makes up the software, and thus which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

FIG. 1A shows examples of relationships between the various participants for an example embodiment. In particular, the relationships between the plan advisor 20, money managers (experts) 21 (who expertly manage the model portfolios 30), plan sponsor 22, and the employees of the plans (the investors) 23 is shown. The plan sponsor 22 and employees 23 will typically interact with the system 1 through respective computing devices 32, 33, where communication may be through a record keeper site 5 for keeping confidential plan and employee records which may not be used or stored by the system 1. The plan advisor 20, which may not need direct access to the system 1, communicates with the plan sponsor and fiduciaries 25 through appropriate channels as needed to ensure that the plan meets the needs of the employee and complies with appropriate law.

FIG. 2 is a graphical and textual listing of asset allocation risk-based model portfolios constructed for use by the system, such as may be created by financial investment experts with specialized expertise for preparing and managing such portfolios. These portfolios may be constructed as provided in previously cited '889 reference. FIG. 2 shows 8 example model portfolios (any number of portfolios could be used as an alternative), ranging from the highest return, highest risk mostly stock portfolio 30 to the lowest return, lowest risk all cash/stable value portfolio 37. Portfolios 31, 32, 33, 34, 35 and 36 represent increasing transitions from higher return, higher risk, to lower return, lower risk model portfolios, each comprising different combinations of investments, including differing combinations of stocks, bonds, money market, mutual funds, futures, commodities, alternative investments etc. Each one of these model portfolios might be managed by a different expert having particular expertise in the asset allocation model used by the portfolio. Hence, in contrast to the target date funds of the prior art where fund allocation models must change over time, making efficient and effective management difficult, these model portfolios of FIG. 2 can have static performance requirements, better allowing for expert management of the individual portfolios.

Alternatively, rather than using risk-based portfolios, the system might also use, or alternatively use, age-based target date model portfolios, each of which can be directed at a different retirement target date. Such funds are managed by experts such that in their early stages, relatively far from the target retirement date, the fund is aggressively managed for high returns and relatively high risk, but as the current date moves toward the target retirement date, the assets of the funds are changed to transition the fund to a lower risk, but also lower return, model.

Any number of such age-based model portfolios might be provided to provide the desired target date granularity, such as providing a fund for a retirement in each of the next four or five decades, or if higher granularity is desired, every half decade, or every two years, etc. As the number of such funds increases, the assets can be better managed toward the circumstances of the specific retirement goals of the investors, but at a higher expense and complexity.

An example system might also use both risk-based model portfolios and age-based model portfolios to offer a wider range of investment options, with retirement investing use one, the other, or a combination of both types of model funds for investing.

FIG. 3 provides a high-level flow chart showing an example methodology for an example system that starts with some of the features provided by the '889 reference, for example (or some other portfolio assignment process), but that is extended and modified to provide the additional features disclosed herein. The example system requests some basic information from the investor (or the plan administrator, portfolio manager, fiduciary, or employer or any combination of these) 100, such as name, age, beneficiary information (including spouse or significant other's age and employment information), desired retirement dates, etc. This information is typically already in census with Record Keeper, Payroll Provider, Plan Administrator, etc. This information could be input by filling out a web form, for example, by a user using a computer connected to the system (such as shown in FIG. 1) or by a paper application that is manually or automatically entered into the system, for example, or via a telephone inquiry, for example.

If the example system intends to implement the prior art system similar to that shown by the '889 patent by using questionnaires where the investor is willing to participate, the system requests that a questionnaire be completed 102 by the investor for use in determining that investor's investment profile. Such a questionnaire can be provided as a series of web form pages, by telephone, or on paper, for example. The system checks 103 to see if the investor properly completed the questionnaire to the extent necessary to implement the investment process, in which case the prior art approach 105 can be used to select the proper current model portfolio 109 for the investor.

However, if the check 103 shows that the questionnaire has not been properly completed, for whatever reason, or that the investor does not want to complete the questionnaire, or that the questionnaire is/was completed improperly, or that the participant is to be automatically enrolled/QDIA, or otherwise a questionnaire is not to be used, then the example system determines the appropriate model portfolio for the investor 107 in an alternative manner, such as discussed elsewhere in this document (such as by using the investor information entered in step 100, or information otherwise known about the investor, such as through employment records). In this case, the system-selected current model portfolio 109 (or collection of model portfolios) is invested in by the system on behalf of the investor. The system proposed solution can be provided to the investor for approval before the actual investments are purchased, if desired, perhaps giving the investor some leeway to change the fund/portfolio, which may be similar to the process provided by the '889 application for adjusting proposed portfolios, for example. Alternatively, these portfolios may be managed by the fiduciary or plan manager, for example, and in some cases the investor may not be permitted any changes to the recommendation provided by the system.

Periodically, the system updates the information for the investor 111 (e.g., updates investor age, beneficiaries, income, etc.) and the system checks to see if the suggested model portfolio should be changed 113, such as by checking for a threshold change in the investor status. If it is necessary to change the model portfolio or a part thereof, the system determines the necessary update to the model portfolio(s) 115 and moves part or all of the investor's investments to a new current model portfolio 109, and then continues adjusting the investor information 111 over time to continue adjusting the current model portfolio investments to changing information, when necessary. These changes may be managed and/or approved by the fiduciary or plan manager, for example, or they may require advance investor approval, or both, for example.

In some cases, all of the investor's money may be moved from a current model portfolio to a new model portfolio in response to the investor changes. In other cases, only part of the money may be moved. For example, in the case of beneficiaries in different circumstances, the investor may have a portion of the total investment allocated to a different model portfolio for each beneficiary to meet the expected financial needs of each beneficiary based on that beneficiary's status.

The types of status change that may be monitored for updating investments can be extensive, and typically will have a threshold to reach before an updated in investment is implemented. The status change can include changes in the age (e.g. passage of 1, 2, 5, 10, etc., years), desired retirement date/age (e.g., defer or accelerate retirement), job status (e.g., promotion, unemployment, change of job, etc.), marital status (e.g., a marriage or divorce or death of a spouse), addition/deletion of beneficiaries (e.g., a birth, death, removal as beneficiary, etc.), change in status of beneficiaries (e.g., aging, sickness, etc.), reaching specific milestones (e.g., graduations, anniversaries, births, deaths, etc.), among others. The thresholds are chosen to be important milestones or a sufficient magnitude of change (e.g., passage of a certain number of years) to avoid changing investments too often which could lead to excessive fees, etc.

FIG. 3A is a flow chart showing a modification to the approach reflected in FIG. 3, with slightly different flows, but implementing a similar process. For either approach, the system can accommodate both the '889 application method of assigning model portfolios to the investor where the investor properly completes the questionnaire, but instead assigns the investors to the model portfolios using an age and/or retirement goal based mapping when the investor does not properly complete the questionnaire.

Note that the system could also continue to request that the investor properly complete the questionnaire periodically, and should the investor do so, the model portfolio could then be changed over to a model portfolio or combination of model portfolios that is/are selected using the prior art process disclosed in the '889 reference, or some other process to replace the age-based process, if desired, or the investor may be given such an option.

Table 1, provided below, shows one example of mapping of the model portfolio to a given investor class (designated A-H), for an individual investor with no beneficiaries, with example age brackets and projected retirement dates also being shown, taking into account the particular life circumstances of the investor (e.g., his age) (typically one or the other would be used):

TABLE 1
EXAMPLE MODEL PORTFOLIO MAPPING NO BENEFICIARY

| | | | Target |
|---|---|---|---|
| | Investor | Investor Age | Retirement |
| Model Portfolio (FIG. 2) | Class | Brackets | Date Range |
| High Growth 30 | A | 20-29 | 2050+ |
| Growth 31 | B | 30-39 | 2049-2040 |
| Moderate Growth 32 | C | 40-49 | 2039-2030 |
| Moderate 33 | D | 50-59 | 2029-2023 |
| Moderate Conservative 34 | E | 60-64 | 2022-2016 |
| Conservative 35 | F | 65-69 | 2015 |
| Income 36 | G | 70+ | retired |
| Fixed Cash 37 | H | Not Recommended | |

An example system could use such a table to select an age appropriate model portfolio for an investor that does not have any beneficiaries. However, in a situation where an investor has a spouse or some other beneficiary, the investor class provided in Table 1 can be adjusted to take any age differences (or retirement date or lifespan differences or other life circumstances) of the beneficiary into account. Table 2, provided below, shows one way that this might be done, in that the investor class provided by Table 1 is taken as the starting point, and adjusted as provided in the table (one stops when one reaches the lowest or highest investment level):

TABLE 2
EXAMPLE INVESTOR CLASS ADJUSTMENTS

| Spouse Age Difference | Investor Class Adjustment |
|---|---|
| Spouse 25+ years younger | Move Class up 3 Levels |
| Spouse 15-24 years younger | Move Class up 2 Levels |
| Spouse 5-14 years younger | Move Class up1 Level |
| Spouse within 5 years | Same Class |
| Spouse 5-14 years older | Move Class down 1 Level |
| Spouse 15-24 years older | Move Class down 2 Levels |
| Spouse 25+ years older | Move Class down 3 Levels |

Of course, such adjustments can be varied in other ways. For example, a blended mortality can be calculated by some mathematical formula relying on the expected mortality dates of any or all of the beneficiaries. Alternatively, the amount of adjustment (or the blended mortality) might depend not only on the age difference between the investor and the beneficiary, but also rely on the starting investor class, such that the age differences that trigger an investment class change may be dependent upon the original class, rather than fixed as in Table 2.

For example, Table 2 may apply only to investors who originally fall into classes B-D, with a different table applying to investors who originally fall into classes greater than D, or less than B. For example, because any investor who may originally fall into classes A or B is relatively young, it may not matter if that investor is married to a spouse substantially older than the investor, as the original class as proposed by Table 1 can be used because the investor's young age predominates the investment decision, whereas any investor who is much older than his or her spouse will likely need a more aggressive portfolio assigned to that investor than would be proposed by Table 1, in which case the spouse's age predominates and Table 1 could be used based on the age of the spouse, for example. Alternatively, the model portfolio might be chosen based on the age bracket of the younger of the investor or the spouse, such that Table 1 is used based on the age bracket of the younger one of the two.

Alternatively, the chosen model portfolio could rely on a more complex formula, such as by taking into account the ages of the investor and his or her spouse, any dependents and their ages, their current life expectancies (which may or may not take into account actual medical conditions), and perhaps even desired retirement dates, or any combination of these parameters. For example, a portion of the investment might be invested based on the investor's age, and another portion of the investment might be based on the age of the spouse, and/or based on the ages of any additional beneficiaries. Thus, in a situation where there is the investor, a spouse, and a young child, the investment might be broken into three parts, with one part being invested based on the age of the investor, another part based on the age of the spouse, and a third part based on the age of the child.

Or alternatively, the investment may be allocated to a plurality of funds to obtain a hybrid risk/return, with the allocation changes as the investor's life circumstances change. Thus, for example, for an unmarried investor with no children who will retire in about 10 years, the system may allocate 20% in an aggressive fund, 60% in a conservative fund, and 20% in a cash fund, for example, rather than investing all of the investment into a single fund.

As still another alternative, age-based target date portfolios could instead be used, in which case initial investments may remain indefinitely in the originally targeted funds. In this case, the investment may be allocated amongst a number of such age-based target portfolios to also accommodate beneficiaries of the investor, such that the desired investment targets of those beneficiaries are also taken into account. In such a case, the system could invest the funds in a manner such as provided in the example of Table 3:

TABLE 3
EXAMPLE Age-Based Allocation with Beneficiaries

| Spouse Age Difference | Investor Class Adjustment |
|---|---|
| Investor Target Retirement 2024 | Invest 45% in 2020 Target Date Fund |
| Spouse Target Retirement 2028 | Invest 25% in 2030 Target Date Fund |
| Child 1 Graduation 2018 | Invest 17% in 2040 Target Date Fund |
| Child 2 Graduation 2022 | Invest 13% in 2050 Target Date Fund |

Hence, as shown in Table 3, a portion of the funds are invested in age-based portfolios based not only on the expected retirement date of the investor, but portions are also invested based the expected retirement date of the investor's spouse, and portions are further invested based on the expected High School graduation dates (or ages) of the investor's two children. The investment amounts and selected funds for the children could be chosen based on a desired target amount of money to be left to the children upon an expected death date of the investor (or the investor's spouse), or expected college expenses, or some other parameters that are obtained from the investor and utilized by the system in determining the selected funds and investment portions.

In the example of Table 3, the funds for the children's portions of the investment were likely chosen based on a desired amount to be provided in the investor's estate for the children, as the funds have target dates relatively far into the future. Should the target for the funds be college attendance dates, the fund target dates would likely have been much closer to the dates of college attendance, such as shown in Table 4, below:

TABLE 4
EXAMPLE Age-Based Allocation Support Child College

| Spouse Age Difference | Investor Class Adjustment |
|---|---|
| Investor Target Retirement 2029 | Invest 45% in 2020 Target Date Fund |
| Spouse Target Retirement 2031 | Invest 25% in 2030 Target Date Fund |
| Child 1 HS Graduation 2018 | Invest 18% in 2020 Target Date Fund |
| Child 2 HS Graduation 2027 | Invest 12% in 2030 Target Date Fund |

Note that for the case of children beneficiaries, the system could be configured to accommodate changes in status of the child. For example, children might only be taken into account when they are very young, with diminishing influence on the investment decisions as they age, until their influence is eliminated, such as when they reach adulthood, or college graduation, for example, when they are expected to care for themselves. Also, the objective of the investment could also be taken into account, such as whether investing for college education is the goal, or if leaving the child a larger cash estate is desired, for example.

Thus, the system in at least some embodiments permits wide flexibility in how to choose the appropriate risk-based model portfolios, and/or age-based model portfolios, for the circumstances of a given investor, with the important feature being that the investments are age appropriate, using investments in the model portfolios, but also taking into account the circumstances of the investor's beneficiaries.

Furthermore, when using risk-based model portfolios, the portfolios themselves are not individually adjusted, rather the investor's investments is moved from one model portfolio to another based on changes in the investor's life circumstances and the advance of time (e.g., as the investor and his beneficiaries, if any, get older and approach retirement or expected end-of-life, or life expectancy changes due to health conditions or improvements in healthcare, etc.). Such a system can be configured to consider a large variety of different investor criteria for determining the optimum investment model portfolio for that investor. These criteria can be weighed in any of a number of ways, with such weighing, and even the chosen criteria, changing over time in response to changes in the investor's status, societal changes, or other changes that would impact the financial needs of the investor.

An additional improvement that can be provided in some embodiments of the above described system, or that could be utilized by other investment systems, involves the application of dollar cost averaging (DCA) to retirement accounts, such as 401(k) accounts. This approach can be used in a system such as the examples disclosed in the '889 patent, or to any of the example systems disclosed herein, or any other investment system. For this improvement, when an investor desires to purchase an investment, such as investing in a given model portfolio, or when the investor decides to sell investments in one portfolio for investing in another portfolio, or where the system is transitioning from one model portfolio to another model portfolio as a result of changing investor circumstances, or even when an investor desires only to sell a portion of a current investment without re-investing, the investor or the plan administrator may desire to purchase (or sell) the new investment using a DCA approach called Auto Pilot Dollar Cost Averaging (APDCA), in which DCA is applied automatically by the system to a desired investment purchase by such a system.

Hence, an APDCA enabled system will accept an input from the investor indicating that the system should use APDCA to sell and/or purchase a desired investment using cash, or when all or part of one investment is sold to purchase another investment, for example. Such a request could be input by the investor checking a checkbox provided by the system for investor input (such as on a web page generated by the system), such as when an investment change is requested by the investor where using APDCA is desired. Alternatively, the system may accept a global account setting from the investor that APDCA should be used for all investment purchases as a default. As another alternative, the system could prompt the user to indicate whether or not APDCA is desired for any sale or reinvestment opportunity, when that is an appropriate action to a transaction being requested by the investor. Alternatively, APDCA may be set as a default option by the plan administrator or fiduciary, for example. APDCA might also be used in selling an asset being sold, if desired, such as when liquidating an investment, so that sale occurs over time to reduce the risk of such a sale.

FIG. 4 is a flow chart showing one example implementation of the APDCA option. When the system receives a request to make a fund or other investment purchase using APDCA 201, the system has a number of parameters that it needs to use to implement the APDCA approach. The system utilizes some combination of the parameters of: the total purchase amount ($), the incremental purchase amount (k), the total number of incremental purchases (m), the time to completion (T), the initial purchase date (t), and/or the period between incremental purchases (p), for implementing the purchase transactions. Hence, in step 203 the system requests various parameter values, and in step 205 it calculates those values that it can, depending on which of the parameters have known values, and which are unknown. If the system still needs additional parameter values from the investor, or the investor wants to change some values 207, the system again accepts inputs 203 until both the system and the investor are satisfied 207.

There are a number of different ways to determine values for these various parameters, but typically the system ultimately needs to know how many transactions to make (m), the amount of each transaction (k) and the period between transactions (p), to implement APDCA. But there are various different alternatives ways to determine these values, and thus the system can request various alternative inputs from the investor to implement the process.

For example, the investor might provide the necessary values directly, inputting the incremental transaction amount (k), the total number of transactions (m), and the period between transactions (p), along with the start date (t). Or, the investor might be prompted to input a total transaction amount ($), and the number of purchases (m), and the period of the purchases (p), with the start date (t), in which case the system calculates the incremental purchase amount (k) and determines the time to completion. Or the investor may indicate the total amount ($), the period (p), the time to completion (T), and the start date (t), in which case the system calculates the number of purchases (m) and the incremental purchase amount (k) (i.e., m=(T−t)/p and k=$/m). Hence, there are a number of different ways to determine the various parameters depending upon which information is to be provided by the investor. Any or all of these approaches might be used by the system, or some other combination of known and unknown values could be used. The last DCA may be lower than the previous amount.

Note that for a relatively simple implementation of the APDCA feature, the period between purchases, (p) can be fixed by the system (such as monthly, or bi-weekly, for example), in which case the investor need provide only a total transaction amount ($), start date (t), and a time to completion (T), in which case the system can automatically calculates the other parameter values and implements the process. For an even simpler system, the number of purchases (m) could be fixed (e.g., 6 monthly purchases to start on the next transaction date), in which case all that is needed is the total amount $ (and perhaps an execution or start date where that is not immediately), and all of the other parameters can be calculated.

Where it is intended that the investor (or the plan advisor or some other party) provide values for some of the parameters to implement the APDCA, the system can be adapted to accept direct inputs from the investor (or other person) for those values. For example, if the user selects to use APDCA for an investment purchase, the system may prompt the user by requesting an input of values for some subset of the parameters into a web form, so that the other parameters can be calculated. The system might allow the investor to choose some necessary combination of the parameters ($), (m), (T), (p), (t), or (k), with the system calculating the remainder for display. For example, FIG. 5 shows an example web form page having all these parameters, where when the investor inputs desired values of a subset of the desired parameters in various input fields until the remainder of parameters can be calculated by the system. The investor may then be offered the ability to change some of the parameters, resulting in an update of the other parameters, for example.

The system can help the investor input the values by indicating which variables should be entered to calculate the others, or by providing recommended default values. For example, when the investor enters values into one field, the system might highlight in red other fields that require inputs (or use a popup window to list them, for example). Hence, if the investor inputs a total investment amount ($), the fields for the remaining fields will all be shown in red, but if the investor inputs a value into the incremental purchase amount field (k), the total number of purchases (m) can now be calculated ($/k), and hence that field no longer will show red but will instead show the system calculated value ($/k), while the other remaining fields will show in red. If the investor then puts a start date (t) and a purchase period (p), then the Time to Completion (T) will be calculated, and all parameters are properly provided to the system.

The system can be adapted to provide the investor with the option to change some values, and the system will adapt other values accordingly. For example, when a change in one variable requires the investor to also change some other variable, the system might highlight the variables that still need to be updated (e.g., in red) or the system may provide a pop up message describing some possible approaches that will allow the other variables to be updated. For example, if the values of FIG. 5 are populated with one scenario, and the investor decides to change the Total Investment Amount, then the system cannot know which of the other variables to change, and hence the investor might be prompted to change others of the variables, or indicate to the system which variables are not to be changed, for example. Improper combinations will be indicated as being in error, or canceled out by the system, for example.

The purchase period (p), may be provided as a limited number of options in a pull down menu, for example, or may be fixed by the system or by the plan administrator. Or the total number of periods (m) may be fixed (by the system or plan administrator), requiring that the investor provide either the total transaction amount ($) or the incremental purchase amount (k). Or the system may only allow fixed amounts for the incremental purchase amount (k), for example. The system might also allow the investor to choose the day of the month that investments are made, for example.

Referring back to the flow chart of FIG. 4, once the purchase parameters (m, p, and k) are known for a desired transaction and stored in the database 204, the system will make a (first) incremental purchase 209 of k amount at the intended first purchase date. The system then checks to see if all of the incremental purchases have been made yet 211, and if not, the system then waits a period 213 p to make another incremental purchase 209 of amount k. This continues until m purchases have been made 211, and thus the total transaction amount ($) has been purchased and the process ends. This information and current status can all be stored in a system database to track the progress of the purchases. The system may send out notifications, such as by email, to investors to provide progress reports.

Other approaches could be utilized. For example, the system may always use a fixed period (p) and fixed total number of purchases (m) for any transaction for a particular investor, in which case the only parameter to be input to the system by the investor is the total transaction amount ($), for example. But for any of these approaches, some version of dollar cost averaging can be provided to the investor in the retirement account (such as a 401(k) or IRA, for example), however the system might implement such a feature, to enable the investor using such a system to obtain the benefits thereof.

As a further extension, the APDCA process can be made dependent upon various market conditions or changes. For example, the incremental purchase might be made to depend on the movement of a particular index, for example. Hence, the user might want to trigger, start, or stop, an incremental purchase if an index has dropped or risen by a certain amount. For example, an investor might request that an incremental purchase be stopped if the S&P 500 has dropped 4%, for example, or another investor might want to increase an incremental purchase amount if the P/E ratio for the S&P 500 rises or falls a certain amount, or when an index has passed a benchmark, for example. Or the investment decisions can be made dependent upon the rise or fall of indices of the model portfolio being purchased or sold, for example.

For these more complicated procedures, the system can be configured to request additional information from the investor (or some other party, such as the plan administrator, for example) for determining APDCA investment parameters. For a simpler approach, the system might implement a stop option that lets the investor cancel an APDCA activity upon a given index rising, or falling, a certain amount. For example, the system might provide a pull-down menu on an input screen that has various stop criteria listed. FIG. 6 shows an example data entry screen providing a means of inputting such information, where window 301 is a drop-down window showing various indices that can be chosen to stop an event, and field 303 where the user can input a percentage to trigger the stop. For example, the user might chose to select stopping a given APDCA process when gold drops by a certain amount by selecting “stop if gold drops” from the drop-down menu field 301, and then entering an amount, e.g., 15, into field 303, in which case the system will cancel the future pending APDCA transactions if the price of gold drops by 15%. Another window could be used to set a condition for resuming the APDCA transactions, if desired. Thus, an investor might choose to resume incremental purchases under that APDCA process if the S&P 500 falls by 20%, for example. In some instances, the participant may elect to double or triple up or go all back into the market when the drop is greater than or equal to a certain percentage. There are an almost infinite combination of parameters that could be utilized for such options.

Even more complicated scenarios can be implemented in a similar manner by providing various means of requesting inputs from the user, and then scheduling, increasing or decreasing (in number and/or amount), canceling, and/or resuming incremental purchases based on any of a number of conditions for APDCA procedures set up by the investor.

Furthermore, one-time transfers from one investment to another investment could also be requested upon the occurrence of certain market or investment conditions separate from use with APDCA. For example, an investor might request that a certain amount, or a certain percentage, of a given investment be moved from a more aggressive model portfolio to a less aggressive model portfolio when the S&P 500 drops by 7.5%, for example, but that cash be used to purchase an aggressive model portfolio if the S&P drops by 15%, for example. The system could support many other such scenarios being set up by the investor. In this way, the system can be used to automatically respond to various market or investment conditions without any need for the investor to continuously monitor those conditions in real-time. Any of these options can be utilized by providing the appropriate parameters on input screens in a user interface, similar to the manner described above for the simpler scenarios, to allow the uses to implement the features according to the investor's desired parameters.

Many other example embodiments can be provided through various combinations of the above described features. Although the embodiments described herein above use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of performing automated investing in a retirement account using a computer system comprising at least one computer and at least one database, said method comprising the steps of:
providing a plurality of model investment portfolios each directed toward different investment criteria;
collecting investor information about a particular investor using said computer system, wherein said information is stored in at least one of said at least one database;
accepting information into said computer system indicating a retirement investment amount of the particular investor;
determining, using said computer system, particular life-circumstances for a particular investor utilizing the investor information;
automatically choosing, using said computer system, a plurality of chosen model investment portfolios chosen from the plurality of model investment portfolios, wherein said choosing is at least partly based on the particular life-circumstances of the particular investor; and
automatically determining, using said computer system, a different calculated portion of the retirement investment amount of the particular investor to be allocated to each one of the plurality of chosen model investment portfolios, wherein said determining is at least partly based on the particular life-circumstances of the particular investor;
investing, using the computer system, at least a portion of the retirement investment amount of the particular investor into the chosen model investment portfolios according to the respective calculated portions;
detecting, using the computer system, a threshold change in the life circumstances of the particular investor; and
in response to detecting the threshold change, adjusting the portions invested in the chosen model investment portfolios.

2. The method of claim 1, wherein each one of said plurality of model investment portfolios is an age-based investment portfolio that is expertly managed at least partly based on a different respective target retirement date such that the risk/return profile changes over time.

3. The method of claim 2, wherein the portion invested in the each one of the plurality of chosen model investment portfolios is designed to remain invested in the chose model investment portfolios until a target retirement date of the investor.

4. The method of claim 1, wherein each one of said plurality of model investment portfolios is a different risk-based investment portfolio that is expertly managed to maintain a respective stable risk/return profile.

5. The method of claim 4, wherein the portion invested in the each one of the plurality of chosen model investment portfolios, or the chosen model investment portfolios chosen from the plurality of model investment portfolios for receiving portions of the investment, or both, change gradually over time.

6. The method of claim 5, wherein, for said adjusting, an adjusted portion of said investment invested in one model portfolio is to be invested in another model portfolio by the computer system automatically investing equal parts of the adjusted portion in the other model portfolio over a period of time.

7. The method of claim 5, wherein the particular life circumstances of the particular investor include the number of beneficiaries of the investor and information related to the ages of each of the beneficiaries of the investor.

8. The method of claim 1, wherein the particular life circumstances of the particular investor include a status of the investor, a status of a spouse of the investor, and a status of any children of the investor.

9. The method of claim 1, wherein the particular life circumstances of the particular investor include the number of beneficiaries of the investor and their status.

10. The method of claim 1, wherein the particular life circumstances of the particular investor include the number of children of the investor, the expected retirement age of the spouse of the investor, and information related to the ages the children of the investor.

11. The method of claim 1, wherein the particular life circumstances of the particular investor include the expected retirement age of the investor and the expected retirement age of the spouse of the investor.

12. The method of claim 1, wherein, for said adjusting, an adjusted portion of said investment invested in one model portfolio is to be invested in another model portfolio by the computer system automatically investing equal parts of the adjusted portion in the other model portfolio over a period of time.

13. A method of performing automated investing in a retirement account using a computer system comprising at least one computer and at least one database, said method comprising the steps of:
providing a plurality of model investment portfolios each directed toward different investment criteria;
collecting investor information about a particular investor using a communication device connected to said computer system via a communication network, wherein said information is stored in at least one of said at least one database;
accepting information into said computer system indicating a retirement investment amount of the particular investor from another communication device connected to said computer system;
determining, using said computer system, particular life circumstances for a particular investor utilizing the investor information, wherein said particular life circumstances include a status of the investor, a status of a spouse of the investor and a status of each of any children of the investor;
automatically choosing, using said computer system, at least one chosen model investment portfolio chosen from the plurality of model investment portfolios, wherein said choosing is dependent on all of the status of the investor, the status of the spouse of the investor, and the status of any children of the investor;
automatically determining, using said computer system, a calculated respective portion of the retirement investment amount of the particular investor to be allocated to each one of the at least one chosen model investment portfolio, wherein said determining is at least partly based on all of the status of the investor, the status of the spouse of the investor, and the status of any children of the investor; and
investing, using the computer system, the retirement investment amount of the particular investor into the at least one chosen model investment portfolio according to the respective calculated portion(s).

14. The method of claim 13, wherein each one of said plurality of model investment portfolios is an age-based investment portfolio that is expertly managed at least partly based on a different respective target retirement date such that the risk/return profile changes over time.

15. The method of claim 13, wherein each one of said plurality of model investment portfolios is a different risk-based investment portfolio that is expertly managed to maintain a respective stable risk/return profile.

16. The method of claim 15, wherein the portion invested in the each one of the plurality of chosen model investment portfolios, or the chosen model investment portfolios chosen from the plurality of model investment portfolios for receiving portions of the investment, or both, change gradually over time.

17. The method of claim 16, wherein, when the portion invested in one model portfolio is to be changed to be invested in another model portfolio, the portion is gradually invested in the other model portfolio by the computer system automatically investing equal parts of the portion in the other model portfolio over a period of time.

18. The method of claim 13, wherein the status of the investor includes the expected retirement date of the investor, the status of the spouse includes the expected retirement date of the spouse, and the status of the children include information related to the age of the children.

19. The method of claim 1, wherein, when a portion invested in one model portfolio is to be changed to be invested in another model portfolio, the portion is gradually invested in the other model portfolio by the computer system automatically investing equal parts of the portion in the other model portfolio over a period of time.

20. A method of performing automated investing in a retirement account using a computer system comprising at least one computer and at least one database, said method comprising the steps of:
providing a plurality of model investment portfolios each expertly managed to provide a different level of risk and return;
collecting investor information about a particular investor using a communication device connected to said computer system via a communication network, wherein said information is stored in at least one of said at least one database;
accepting information into said computer system indicating a retirement investment amount of the particular investor;
determining, using said computer system, particular life-circumstances for a particular investor utilizing the investor information, wherein said particular life circumstances include a status of the investor;
automatically choosing, using said computer system, a plurality of chosen model investment portfolios chosen from the plurality of model investment portfolios, wherein said choosing is at least partly based on at least the status of the particular investor;
automatically determining, using said computer system, a different calculated portion of the retirement investment amount of the particular investor to be allocated to each one of the plurality of chosen model investment portfolios, wherein said determining is based at least on the status of the particular investor;
investing, using the computer system, the retirement investment amount of the particular investor into the chosen model investment portfolios according to the respective calculated portions;
detecting, using the computer system, a threshold change in the status of the investor;
in response to detecting the threshold change in the status of the investor, automatically re-choosing, using said computer system, a updated plurality of chosen model investment portfolios chosen from the plurality of model investment portfolios, wherein said re-choosing is at least partly based on the change in the status of the investor;
also in response to detecting the threshold change in the status of the investor, automatically determining, using said computer system, a different calculated portion of the retirement investment amount of the particular investor to be allocated to each one of the plurality of further chosen model investment portfolios, wherein said determining is based at least on the change in the status of the particular investor; and
in response to determining the different calculated portion, re-investing, using the computer system, an updated retirement investment amount of the particular investor into the updated chosen model investment portfolios according to the respective different calculated portions, wherein said re-investing includes selling at least a part of the current investment in one or more of the chosen model investment portfolios.

21. The method of claim 20, wherein each one of said plurality of model investment portfolios are expertly managed to provide a different level of risk and return that change over time based on a projected retirement date target associated with a respective one of said plurality of model investment portfolios.

22. The method of claim 20, wherein said change in status of the investor is based on a change in the age of the investor, a change in a beneficiary of the investor, or both.

23. The method of claim 20, wherein each one of said plurality of model investment portfolios are expertly managed to provide a different level of risk and return that are consistent over time based on a target risk/benefit level of the respective one of said plurality of model investment portfolios.

24. A method of performing automated investing in a retirement account using a computer system comprising at least one computer and at least one database, said method comprising the steps of:
providing a plurality of risk-based model investment portfolios each expertly managed to provide a different level of risk and return that is consistent over time;
collecting investor information about a particular investor using a communication device connected to said computer system via a communication network, wherein said information is stored in at least one of said at least one database;
accepting information into said computer system indicating a retirement investment amount of the particular investor from another communication device connected to said computer system;
determining, using said computer system, particular life-circumstances for a particular investor utilizing the investor information, wherein said particular life circumstances include a status of the investor;
automatically choosing, using said computer system, a chosen at least one of the plurality of model investment portfolios, wherein said choosing is at least partly based on the status of the particular investor;
investing, using the computer system, at least a portion of the retirement investment amount of the particular investor into the chosen at least one model investment portfolio;
detecting, using the computer system, a threshold change in the status of the investor;
in response to detecting the threshold change in the status of the investor, automatically re-choosing, using said computer system, an updated chosen at least one of the plurality of model investment portfolios, wherein said re-choosing is at least partly based on the change in the status of the investor; and
in response re-choosing, re-investing, using the computer system, at least a portion of a current retirement investment amount of the particular investor into the updated chosen at least one of the model investment portfolios.

25. The method of claim 24, wherein said change in status of the investor is based on a change in the age of the investor, a change in a beneficiary of the investor, or both.

26. A method of performing automated investing in a retirement account using a computer system comprising at least one computer and at least one database, said method comprising the steps of:
providing a plurality of model investment portfolios each expertly managed to provide a different level of risk and return;
collecting investor information about a particular investor using a communication device connected to said computer system via a communication network, wherein said information is stored in at least one of said at least one database;
accepting information into said computer system indicating a retirement investment amount of the particular investor from another communication device connected to said computer system;
determining, using said computer system, particular life-circumstances for a particular investor utilizing the investor information, wherein said particular life circumstances include both a status of the investor and the status of a beneficiary of the investor;
automatically choosing, using said computer system, a chosen at least one of the plurality of model investment portfolios, wherein said choosing is at least partly based on both the status of the particular investor and the status of the beneficiary of the investor;
investing, using the computer system, at least a portion of the retirement investment amount of the particular investor into the at least one chosen model investment portfolio according to the respective calculated portion(s);
detecting, using the computer system, a change in the status of the investor or a change in the status of the beneficiary of the investor or a change in the status of another beneficiary of the investor;
in response to detecting the change, automatically re-choosing, using said computer system, an updated chosen at least one of the plurality of model investment portfolios, wherein said re-choosing is at least partly based on the detected change; and
in response to re-choosing, re-investing, using the computer system, at least a portion of a current retirement investment amount of the particular investor into the updated chosen at least one of the model investment portfolios.

27. The method of claim 26, wherein each one of said plurality of model investment portfolios are expertly managed to provide a different level of risk and return that change over time based on a projected retirement date target associated with a respective one of said plurality of model investment portfolios.

28. The method of claim 26, wherein said detected change is based on a change in the age of the investor, a change in the age of the beneficiary of the investor, or the addition of the other beneficiary as a new beneficiary of the investor.

29. The method of claim 26, wherein each one of said plurality of model investment portfolios are expertly managed to provide a different level of risk and return that are consistent over time based on a target risk/benefit level of the respective one of said plurality of model investment portfolios.
